(19) United States
(12) Patent Application Publication
(10) Pub. No.: US 2003/0083936 A1
(43) Pub. Date: May 1, 2003

(54) Method and apparatus for dynamic rule and/or offer generation

(76) Inventors: Raymond J. Mueller, Weston, CT (US); Andrew S. Van Luchene, New York, NY (US); Jeffrey E. Heier, Somers, NY (US); Christine Amorossi, Brookfield, CT (US); Srikant Krishna, Holmdel, NJ (US); Ted Markowitz, Darien, CT (US)

Correspondence Address: WALKER DIGITAL, FIVE HIGH RIDGE PARK, STAMFORD, CT, 06905, US

(21) Appl. No.: 09/993,228

(22) Filed: Nov. 14, 2001

Related U.S. Application Data
(60) Provisional application No. 60/248,234, filed on Nov. 14, 2000.

(51) Int. Cl. G06F 17/60

(52) U.S. Cl. 705/14

(57) ABSTRACT

Systems and methods are provided for receiving order information based on an order of a customer; and determining an offer for the customer based on the order information and at least one of a genetic program and a genetic algorithm.

This application claims the benefit of U.S. Patent Application Serial No. 60/248,234, entitled DYNAMIC RULE AND/OR OFFER GENERATION IN A NETWORK OF POINT-OF-SALE TERMINALS, the entire contents of which are incorporated herein by reference as part of the present disclosure.

### CROSS-REFERENCE TO RELATED APPLICATIONS

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Serial No. 60/239,610 entitled “Methods and Apparatus for Performing Upsells” and filed Oct. 11, 2000. The entire contents of these applications and/or patents are incorporated herein by reference as part of the present disclosure.

Reference to Computer Program Listing Appendix

A computer program listing appendix has been submitted on two compact discs. All material on the compact discs is incorporated herein by reference as part of the present disclosure. There are two (2) compact discs, one (1) original and one (1) duplicate, and each compact disc includes the following ninety files:

| | SIZE IN | DATE |
|---|---|---|
| FILE NAME | BYTES | CREATED |
| ActionSet.java | 26,409 | Oct. 31, 2001 |
| ArmTimerOrderProcessor.java | 7,095 | Oct. 26, 2001 |
| BayesRule.java | 6,274 | Oct. 26, 2001 |
| BioNET.java | 22,152 | Oct. 24, 2001 |
| BioNetDatabase.java | 40,708 | Nov. 1, 2001 |
| BioNetNonTerminalException.java | 5,108 | Oct. 30, 2001 |
| BioNetTerminalException.java | 3,140 | Aug. 27, 2001 |
| BioNetUtilities.java | 11,850 | Oct. 18, 2001 |
| Classifier.java | 47,169 | Oct. 29, 2001 |
| ClassifierFieldManager.java | 8,385 | Oct. 30, 2001 |
| ClassifierPopulation.java | 25,894 | Oct. 30, 2001 |
| ClassifierSet.java | 12,784 | Oct. 30, 2001 |
| ClassifierStatistics.java | 13,778 | Oct. 29, 2001 |
| ClassifierSystem.java | 4,248 | Nov. 7, 2001 |
| ConditionalProbability.java | 3,433 | Oct. 26, 2001 |
| ConditionalProbabilityMap.java | 5,566 | Oct. 17, 2001 |
| ConditionalProbabilityMap_Double.java | 2,090 | Oct. 17, 2001 |
| ConditionalProbabilityMap_Integer.java | 1,760 | Oct. 17, 2001 |
| ConditionalProbability_Integer.java | 4,059 | Oct. 26, 2001 |
| ConfigurationEvent.java | 3,373 | Oct. 29, 2001 |
| ConfigurationEventListener.java | 899 | Sep. 4, 2001 |
| DatabaseField.java | 1,773 | Aug. 27, 2001 |
| DBbioNETConfig.java | 15,479 | Oct. 30, 2001 |
| DBcashiers.java | 3,909 | Oct. 31, 2001 |
| DBconfig.java | 4,747 | Oct. 31, 2001 |
| DBdataSubsystem.java | 1,548 | Nov. 2, 2001 |
| DBdataSubsystemFactory.java | 9,749 | Oct. 28, 2001 |
| DBdataSubsystemFactoryPhase1.java | 3,914 | Oct. 28, 2001 |
| DBdataSubsystemFactoryPhase2.java | 3,909 | Oct. 28, 2001 |
| DBdestinations.java | 4,264 | Oct. 31, 2001 |
| DBintDescription.java | 7,553 | Oct. 31, 2001 |
| DBmappedNodes.java | 13,742 | Oct. 31, 2001 |
| DBmenuItem.java | 41,161 | Nov. 6, 2001 |
| DBmenuItemPeriod.java | 19,505 | Nov. 6, 2001 |
| DBmenuItemPhase1.java | 7,273 | Nov. 1, 2001 |
| DBmenuItemProbability.java | 7,266 | Nov. 1, 2001 |
| DBmenuItems.java | 51,588 | Nov. 6, 2001 |
| DBmenuItemsPhase1.java | 4,819 | Nov. 1, 2001 |
| DBperiod.java | 14,043 | Nov. 4, 2001 |
| DBperiodCounts.java | 5,320 | Nov. 4, 2001 |
| DBperiods.java | 27,560 | Nov. 6, 2001 |
| DBregisters.java | 4,228 | Oct. 31, 2001 |
| DebugPrintNothing.java | 1,861 | Nov. 2, 2001 |
| DebugPrintOut.java | 8,181 | Nov. 2, 2001 |
| DigitalDealDatabase.java | 4,175 | Oct. 31, 2001 |
| Evolvable.java | 1,301 | Nov. 2, 2001 |
| EvolverAgent.java | 3,676 | Nov. 2, 2001 |
| GeneratesOffers.java | 1,575 | Nov. 2, 2001 |
| HasNamedFields.java | 1,319 | Nov. 2, 2001 |
| IdenticalOfferAgent.java | 3,467 | Nov. 2, 2001 |
| IdenticalOfferInterface.java | 1,376 | Nov. 2, 2001 |
| InitializeFromResultSet.java | 1,336 | Aug. 27, 2001 |
| Lcs.java | 17,294 | Oct. 30, 2001 |
| LcsItem.java | 2,038 | Nov. 2, 2001 |
| LearnerAgent.java | 6,017 | Nov. 6, 2001 |
| Learns.java | 1,637 | Nov. 2, 2001 |
| MappedNodeInterface.java | 1,254 | Oct. 18, 2001 |
| MappedNodeManager.java | 1,883 | Oct. 18, 2001 |
| MapsPeriodIds.java | 1,202 | Oct. 9, 2001 |
| MenuItemEvent.java | 6,027 | Nov. 1, 2001 |
| MenuItemListener.java | 1,238 | Nov. 1, 2001 |
| ObservedOutcomes.java | 1,812 | Oct. 17, 2001 |
| Offerable.java | 2,042 | Nov. 5, 2001 |
| Offerables.java | 3,005 | Oct. 25, 2001 |
| OfferGeneratingInstance.java | 4,952 | Nov. 6, 2001 |
| OfferGenerator.java | 5,139 | Oct. 19, 2001 |
| OfferItem.java | 20,105 | Nov. 6, 2001 |
| OfferPoolCreator.java | 8,324 | Oct. 26, 2001 |
| Order.java | 15,403 | Oct. 29, 2001 |
| Orderable.java | 1,346 | Nov. 5, 2001 |
| Orderables.java | 1,998 | Oct. 16, 2001 |
| OrderItem.java | 8,136 | Nov. 5, 2001 |
| OrderProcessor.java | 8,737 | Sep. 27, 2001 |
| OverDollarOfferPoolCreator.java | 2,173 | Oct. 26, 2001 |
| PeriodCounts.java | 789 | Nov. 4, 2001 |
| PeriodIdMapper.java | 2,162 | Oct. 26, 2001 |
| PredictionArray.java | 13,648 | Oct. 29, 2001 |
| RefreshAgent.java | 1,769 | Oct. 24, 2001 |
| RefreshListener.java | 1,384 | Nov. 2, 2001 |
| SqlStatement.java | 16,751 | Oct. 24, 2001 |
| StateEvent.java | 2,986 | Oct. 2, 2001 |
| StateEventListener.java | 875 | Sep. 20, 2001 |
| SystemParameters.java | 18,660 | Oct. 29, 2001 |
| TimerArmedOrderProcessor.java | 4,747 | Sep. 26, 2001 |
| TimerThread.java | 1,304 | Oct. 24, 2001 |
| Updatable.java | 1,398 | Oct. 29, 2001 |
| UpgradeAgent.java | 2,644 | Oct. 25, 2001 |
| WakeUpAction.java | 880 | Aug. 28, 2001 |
| XcsInstance.java | 25,626 | Nov. 6, 2001 |
| XcsOfferItem.java | 7,860 | Oct. 29, 2001 |

### BACKGROUND OF THE INVENTION

Everyday, several companies spend significant sums of time and money in an effort to improve their operations. These efforts are manifested in various programs including training, communications, computer systems, product development and more. Historically, computerized systems have been instrumental in controlling costs and tracking performance within all of these disciplines. These systems have grown in flexibility and capability and, in general, have been perfected. Newer systems, like RetailDNA's Digital Deal™ system, are emerging and are now focused on driving increases in revenues and profits. Some of these systems, like the Digital Deal, are rules based and often permit user modifications that can drive incremental performance improvements.

Unfortunately, these systems have not had a mechanism to help change behavior or improve themselves over time. Therefore, the results these systems are able to produce are dependent upon the discipline and performance of store and senior management or systems support personnel. For example, if the database within a labor scheduling package is not kept up to date or routinely “fine tuned” it may become ineffective.

It would be advantageous to provide a method and apparatus that overcame the drawbacks of the prior art.

### DETAILED DESCRIPTION OF THE INVENTION

The present invention can change the way business practices and processes are improved over time. The invention may be used to improve system parameters TM of systems such as the Digital Deal. For example, a system that provides customers with dynamically-priced upsell offers (defined below) may be improved to make offers that are more likely to be accepted. A description of systems that can provide dynamically priced upsell offers may be found in the following U.S. Patent Applications:

U.S. patent application Ser. No. 09/083,483 entitled “Method and Apparatus for Selling an Aging Food Product” and filed May 22, 1998; U.S. patent application Ser. No. 08/920,116 entitled “Method and System for Processing Supplementary Product Sales at a Point-Of-Sale Terminal” and filed Aug. 26, 1997; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997.

Further, the present invention can permit and enable other rules-based applications to become “self improving.”

Various embodiments of the present invention can take advantage of a multitude of data sources and transform these data into genetic codes or ‘synthetic’ DNA. The DNA is then used within an artificial biological environment, which the embodiments of the present invention can replicate. For example, each transaction may be analogized to an individual (species) in a population. When transactions are proven successful under certain environmental conditions (e.g., particular cashier or customer, time of day, day of week, certain store configuration, whether the destination is drive through or dine in, customer demographics), embodiments of the present invention can “propagate” that success. By culling unsuccessful transactions from the synthetic ecosystem, embodiments of the present invention can help eliminate undesirable transactions. Conversely, embodiments of the present invention can encourage the propagation of successful transactions, which drives incremental performance improvements.

The following is an example of one embodiment of the present invention, offered for illustration only.

RetailDNA offers a product referred to as the Digital Deal™, which dynamically generates suggestive sell offers that usually include some form of value proposition (or discount). Customers either accept the offer or they don't. By providing results data from the Digital Deal to the system described herein, overall customer accept rates and customer satisfaction may be improved. Each customer transaction (successful or not) can be translated into genetic strings or DNA. The transactions are measured as to their overall success ratings (success may be defined by subjectively according to any criteria) and includes (in this case), the percentage of customers accepting the deal and the value of the deal to the restaurant operator, and are propagated based upon these ratings. In this way, the system can exploit practices that are known to yield positive results according to various priorities.

In an effort to explore new possibilities, in various embodiments the system may periodically create new combinations of the DNA. In the preceding example, these new DNA combinations are new offers that have not yet been tried or written into rules. Embodiments of the present invention leverage success by distributing these new ideas. The more information that is made available to the system, the faster the system can improve results. Embodiments of the present invention can spread out new ideas over many sites. In such embodiments, the risk and costs associated with introducing a new strand are thereby reduced while simultaneously gathering significant results in a short period.

Embodiments of the present invention may also measure the actual results of both existing and new DNA and may continuously evolve to improve the overall effectiveness of the improved system. Since the whole process is automated, no human intervention is required to continuously improve. Thus, embodiments of the present invention can automatically adjust software settings to continuously generate incremental improvements in operational and financial performance., dramatically changing the way information systems affect the day-to-day operations of businesses. This may be accomplished by, e.g., creating a new model and method for involving and leveraging customers, systems and/or employees within an organization.

The computer program listing appendix included herein describes a program which may be used to practice an embodiment of the present invention.

### DEFINITIONS

The terms listed below shall be interpreted according to the following definitions in connection with this specification and the appended claims.

POS terminal—a device that is used in association with a purchase transaction and having some computing capabilities and/or being in communication with a device having computing capabilities. Examples of POS terminals include but are not limited to a cash register, a personal computer, a portable computer, a portable computing device such as a Personal Digital Assistant (PDA), a wired or wireless telephone, vending machines, automatic teller machine, a communication device, card authorization terminals, and/or credit card validation terminals.

Offer—an offer, promotion, proposal or advertising message communicated to a customer at a POS terminal, including upsell offers (such as dynamically-priced upsell offers), suggestive sell offers, switch-and-save offers, conditional subsidy offers, coupon offers, rebates, and discounts.

Upsell Offer—a proposal to a customer that he or she may purchase an additional product or service. For example, the customer may have an additional product or service added to a transaction.

Dynamically-priced upsell offer—an upsell offer in which the price to be charged for the additional product depends on a round-up amount associated with the transaction. For example, the round-up amount may be the difference between the transaction total (the amount the customer is required to pay without an upsell) and the next highest dollar amount greater than the transaction total. According to this specific example, if the transaction total without the upsell is $4.25, then the round-up amount is $0.75 ($5.00-$4.25=$0.75). In general, the round-up amount may also be based on the difference between any of a number of values associated with the transaction total and any other transaction total. For example, if the transaction total without the upsell is $87.50, the round-up amount may be $11.50, resulting in a new transaction total of $99.00. Other information, such as an amount of sales tax associated with the transaction, may also be used to determine the round-up amount.

Suggestive sell offer—an upsell offer in which the price to be paid for the additional item is a list, retail or standard price.

Switch-and-save offer—a proposal to a customer that another product be substituted for (or sold in lieu of) a product already included in a transaction. In various embodiments, the substitute product is offered and/or sold for less than its standard price.

Cross-subsidy offer (also referred to as a “conditional subsidy offer”)—an offer to provide a benefit (e.g., to subsidize a purchase price, to purchase a product for a lower price) from a third-party merchant in exchange for the customer performing and/or agreeing to perform one or more tasks. For example, a customer may be offered a benefit in exchange for the customer (i) applying for a service offered by a third-party, (ii) subscribing to a service offered by a third-party, (iii) receiving information such as an advertisement, and/or (iv) providing information such as answers to survey questions.

Several embodiments of the invention will now be described with reference to the drawings.

### System Overview

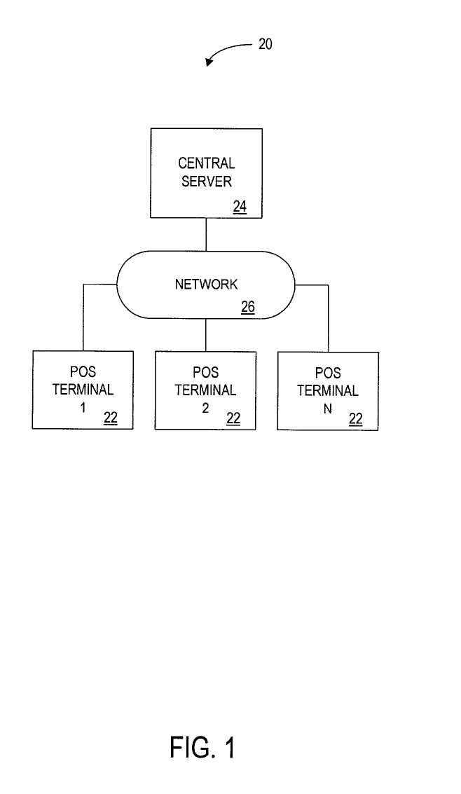

FIG. 1 illustrates, in the form of a block diagram, a simplified view of a POS network in which the present invention may be applied.

In FIG. 1, reference numeral 20 generally refers to the POS network. The network 20 is seen to include a plurality of POS terminals 22, of which only three are explicitly shown in FIG. 1. It should be understood that in various embodiments of the invention the number of POS terminals in the network may, for example, be as few as one, or, may number in the hundreds, thousands or millions. In certain embodiments, the POS terminals 22 in the POS network 20 may, but need not, all be constituted by identical hardware devices. In other embodiments dramatically different hardware devices may be employed as the POS terminals 22. Any standard type of POS terminal hardware may be employed, provided that it is suitable for programming or operation in accordance with the teachings of this invention. The POS terminals 22 may, for example, be “intelligent” devices of the types which incorporate a general purpose microprocessor or microcontroller. Alternatively, some or all of the POS terminals 22 may be “dumb” terminals, which are controlled, partially or substantially, by a separate device (e.g., a computing device) which is either in the same location with the terminal or located remotely therefrom.

Although not indicated in FIG. 1, the POS terminals 22 may be co-located (e.g., located within the same store, restaurant or other business location), or one or more of the POS terminals 22 may be located in a different location (e.g., located within different stores, restaurants or other business locations, in homes, in malls, changing mobile locations). Indeed, the invention may be applied in numerous store locations, each of which may have any number of POS terminals 22 installed therein. In one embodiment of the invention, the POS terminals 22 may be of the type utilized at restaurants, such as quick-service restaurants. According to one embodiment of the invention, POS terminals 22 in one location may communicate with a controller device (not shown in FIG. 1), which may in turn communicate with the server 24. Note that in certain embodiments of the present invention, all the elements shown in FIG. 1 may also be located in a single location.

Server 24 is connected for data communication with the POS terminals 22 via a communication network 26. The server 24 may comprise conventional computer hardware that is programmed in accordance with the invention. In various embodiments, the server 24 may comprise an application server and/or a database server.

The data communication network 26 may also interconnect the POS terminals 22 for communication with each other. The network 26 may be constituted by any appropriate combination of conventional data communication media, including terrestrial lines, radio waves, infrared, satellite data links, microwave links and the Internet. The network 26 may allow access to other sources of information, e.g., such as may be found on the Internet. In various embodiments the server 24 may be directly connected (e.g., connected without employing the network 26) with one or more of the POS terminals 22. Similarly, two or more of the POS terminals 22 may be directly connected (e.g., connected without employing the network 26).

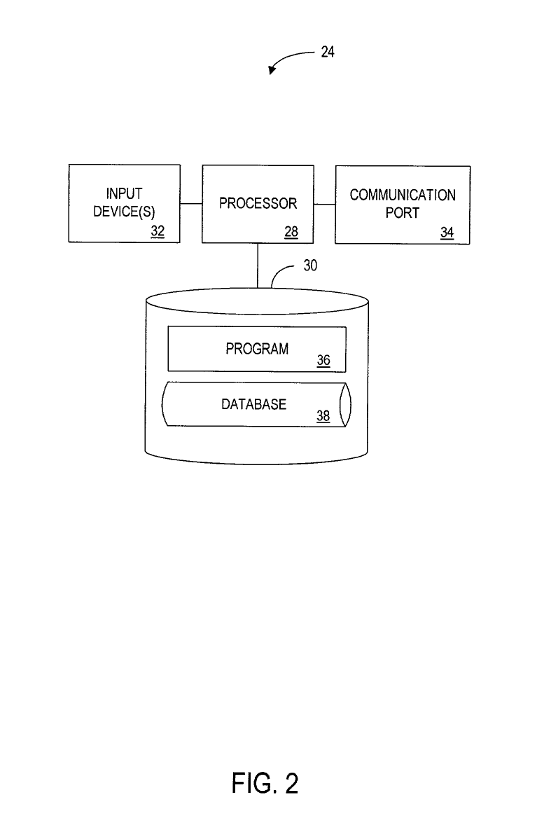

FIG. 2 is a simplified block diagram showing an exemplary embodiment for the server 24. The server 24 may be embodied, for example, as an RS 6000 server, manufactured by IBM Corporation, and programmed to execute functions and operations of the present invention. Any other known server may be similarly employed, as may any known device that can be programmed to operate appropriately in accordance with the description herein. The server 24 may includes known hardware components such as a processor 28 which is connected for data communication with each of one or more data storage devices 30, one or more input devices 32 and one or more communication ports 34. The communication port 34 may connect the server 24 to each of the POS terminals 22, thereby permitting the server 24 to communicate with the POS terminals. The communications port 34 may include multiple communication channels for simultaneous connections.

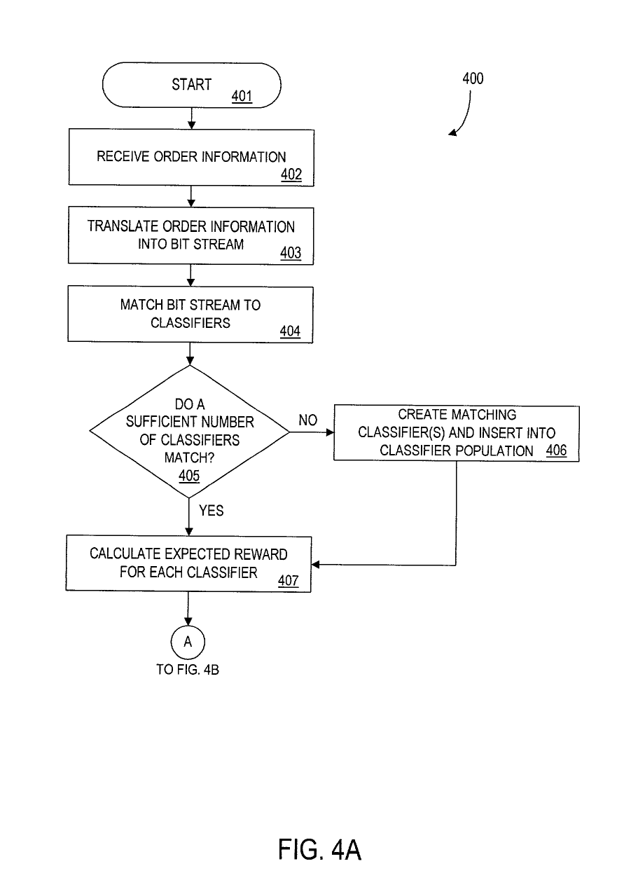

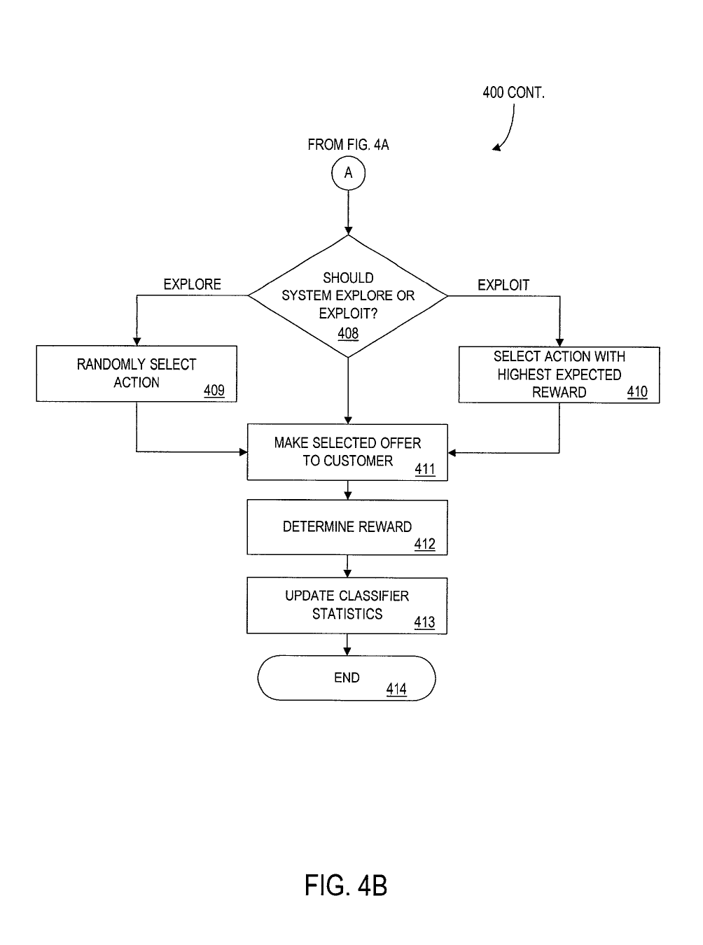

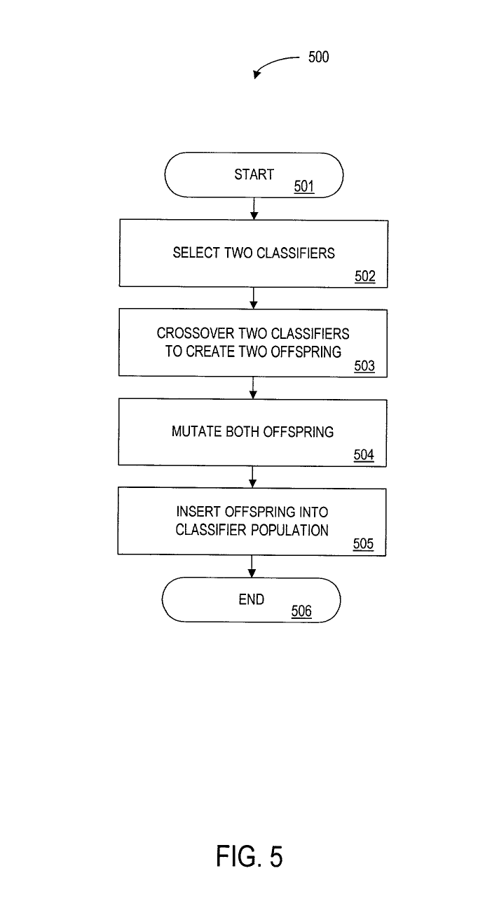

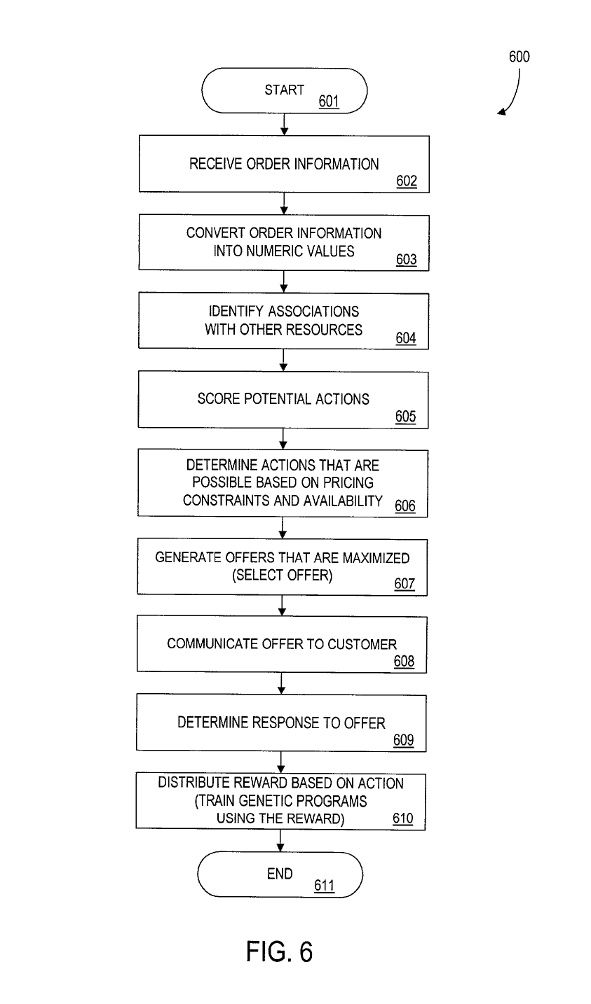

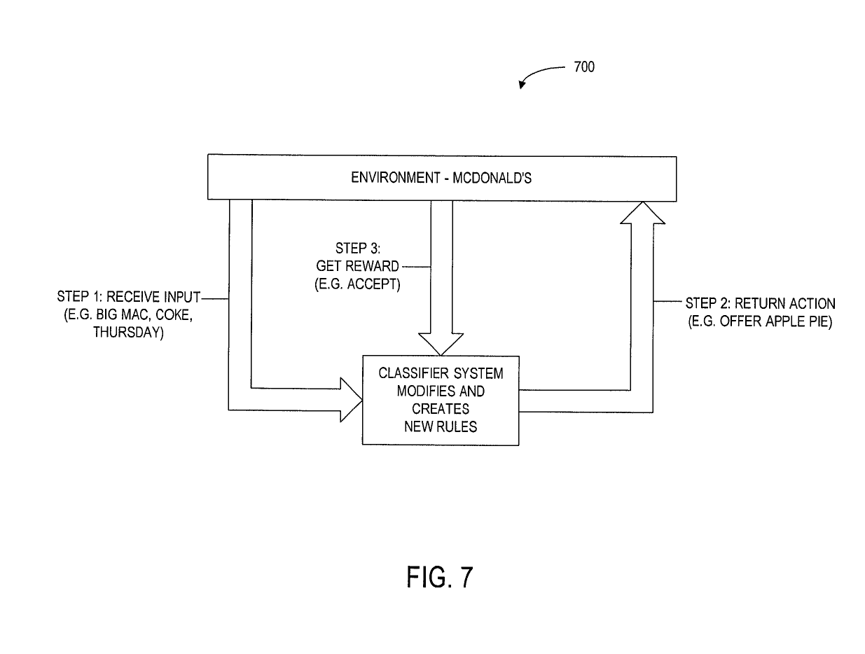

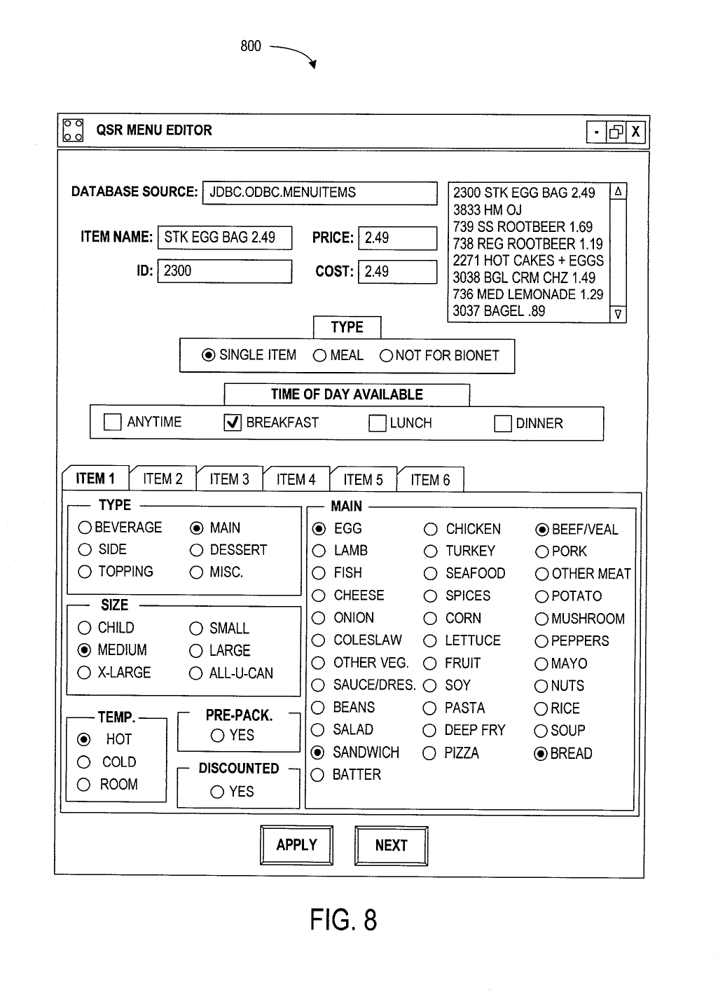

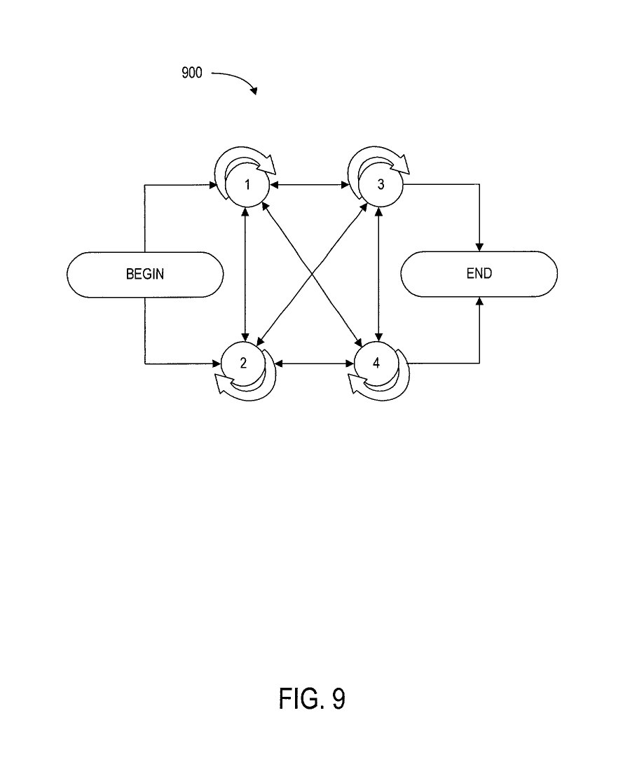

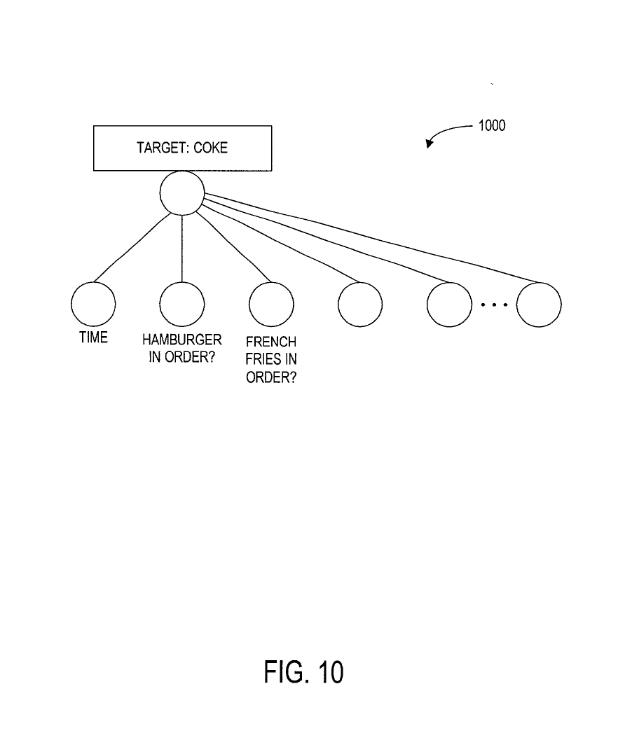

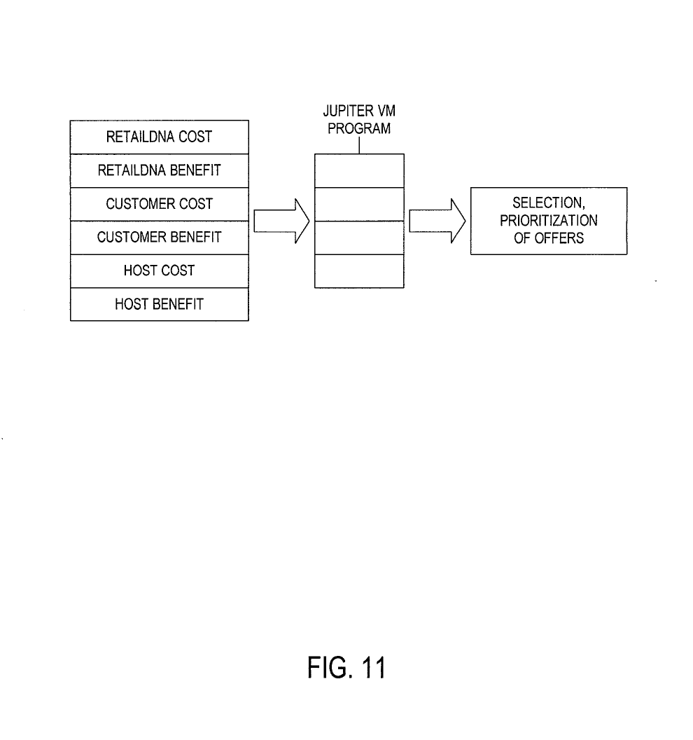

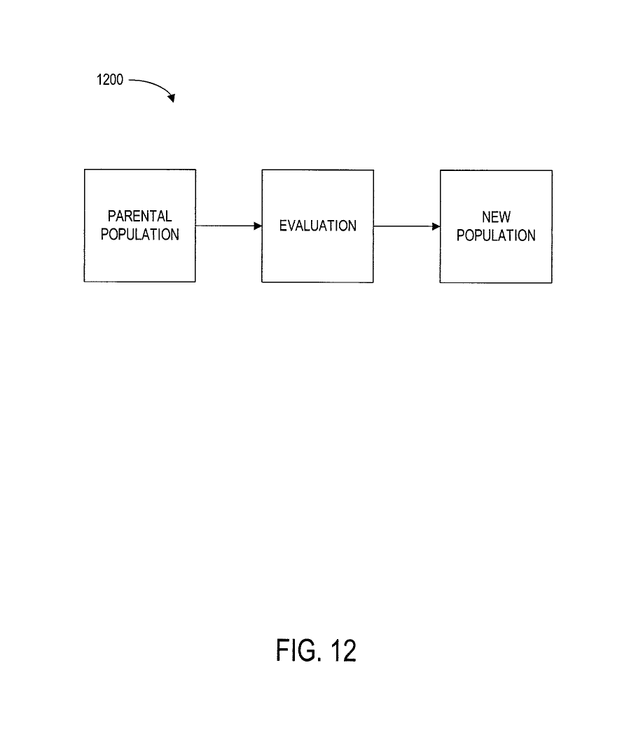

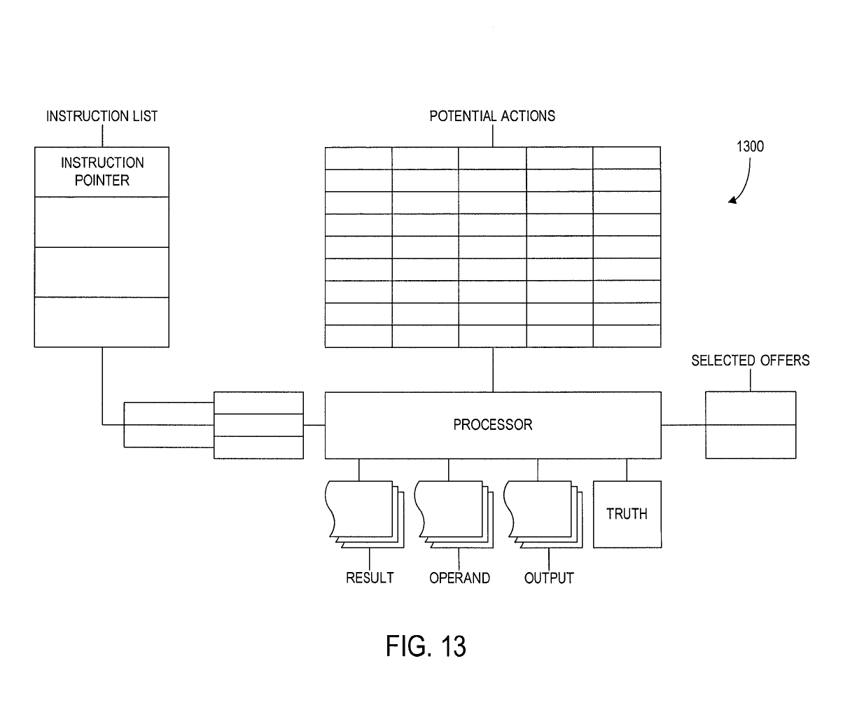

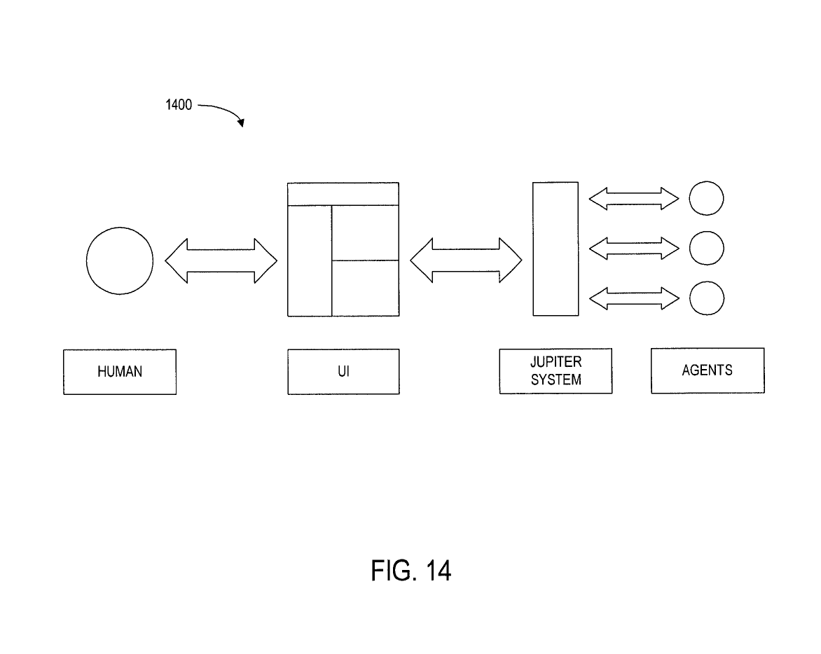

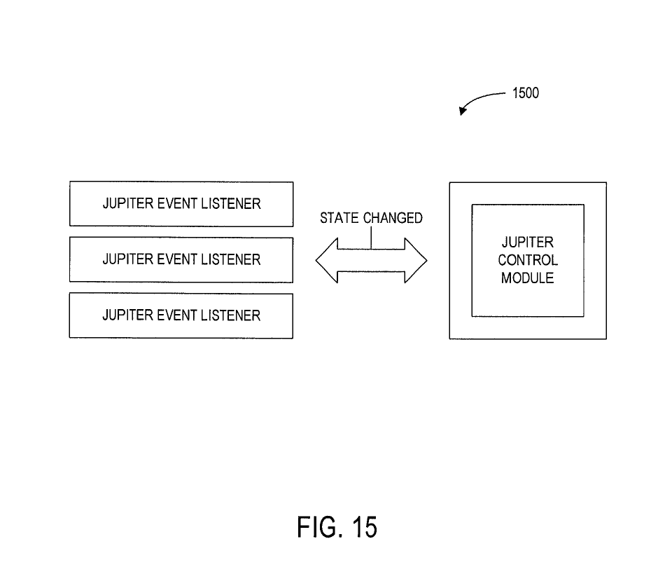

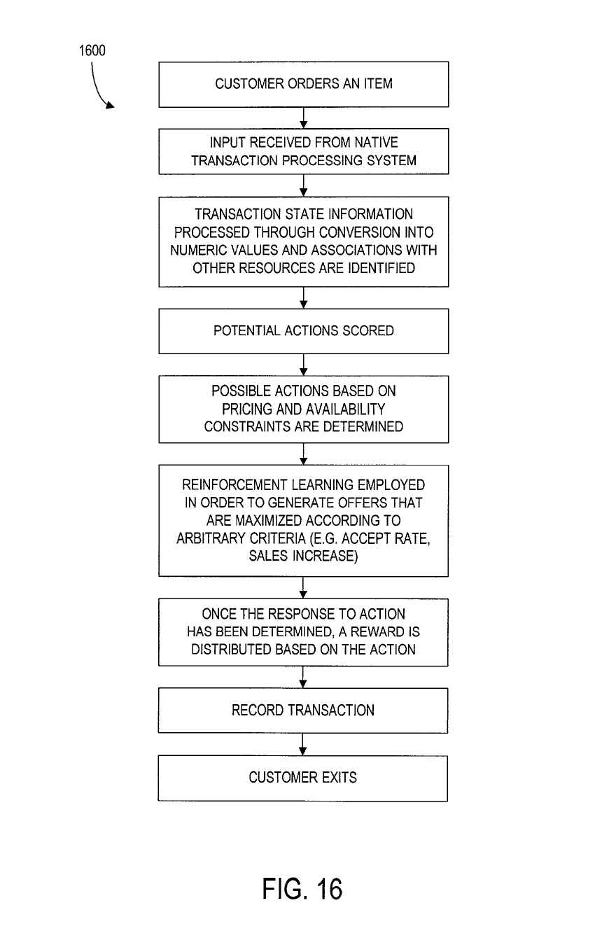

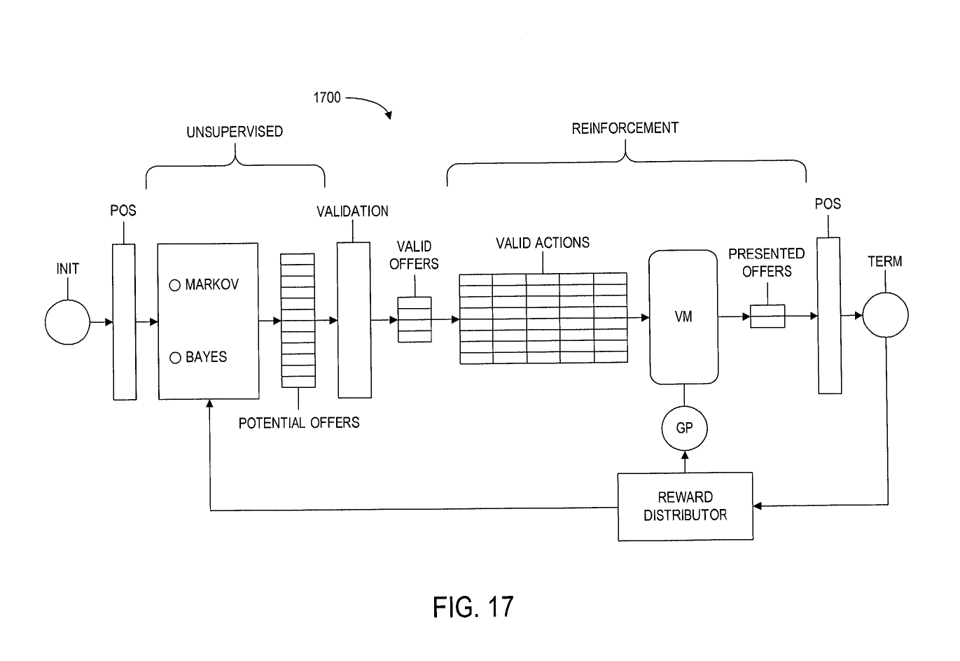

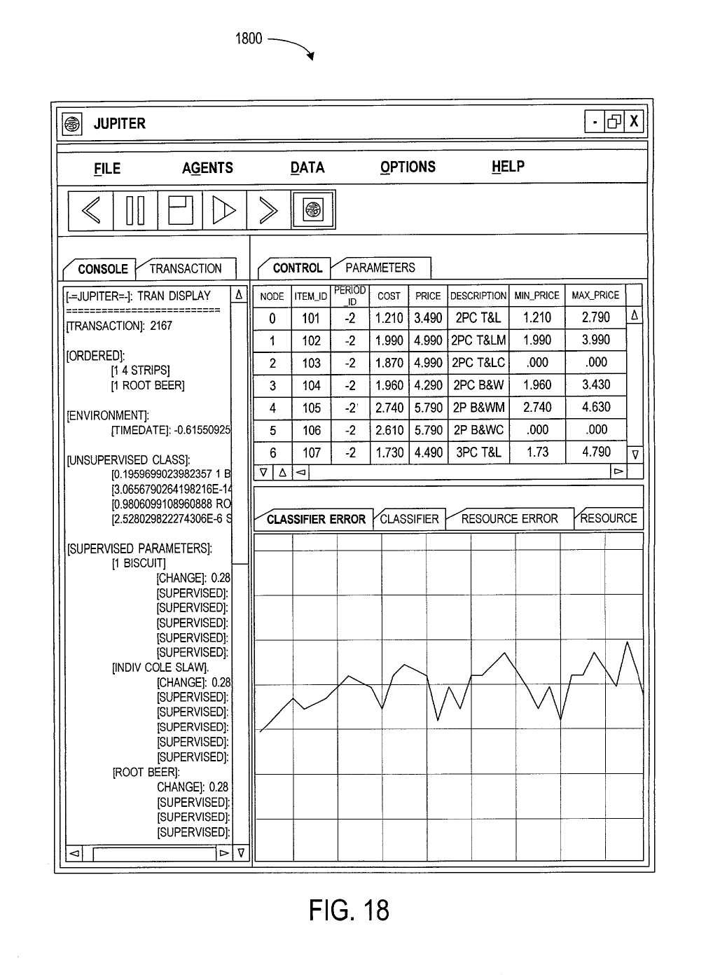

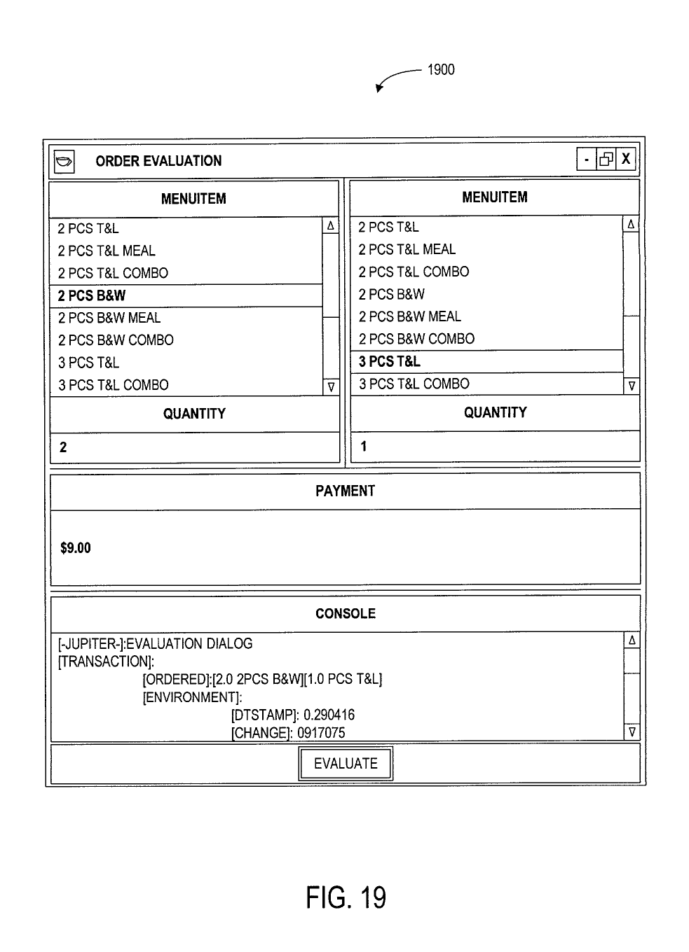

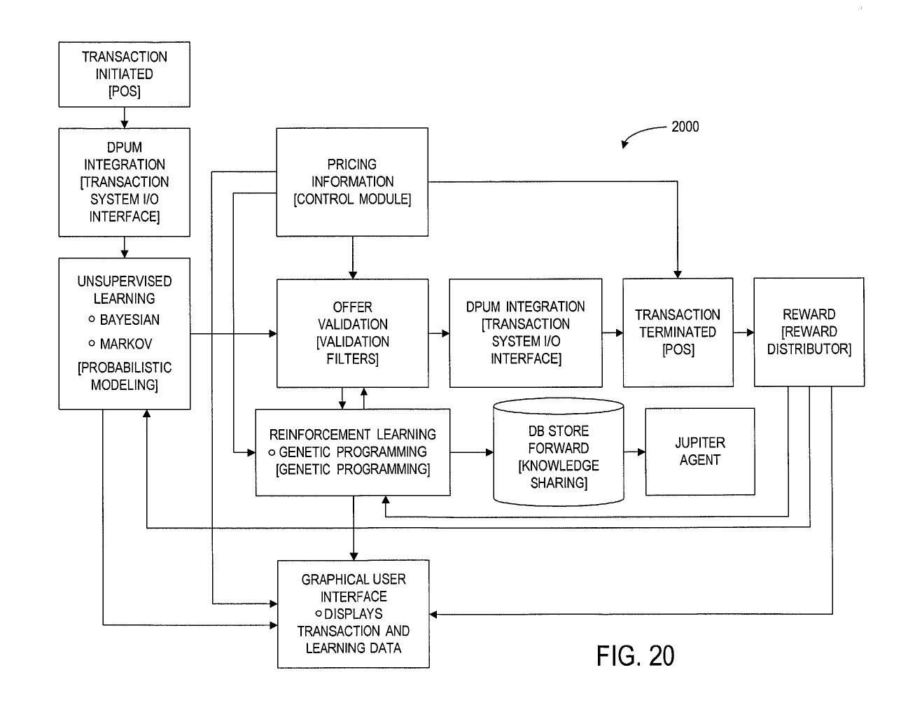

As seen from FIG. 2, the data storage device 30 24, which may comprise a hard disk drive, CD-ROM, DVD and/or semiconductor memory, stores a program 36. The program 36 is, at least in part, provided in accordance with the invention and controls the processor 28 to carry out functions which are described herein. The program 36 may also include other program elements, such as an operating system, database management system and “device drivers”, for allowing the processor 28 to perform known functions such as interface with peripheral devices (e.g., input devices 32, the communication port 34) in a manner known to those of skill in the art. Appropriate device drivers and other necessary program elements are known to those skilled in the art, and need not be described in detail herein. The storage device 30 may also store application programs and data that are not related to the functions described herein. One or more databases also may be stored in the data storage device 30, referred to generally as database 38. Exemplary databases that may be present within the data storage device 30 include a classifier database adapted to store classifiers as described below with reference to FIGS. 4 and 5, a genetic programs database adapted to store genetic programs as described below with reference to FIG. 6, an inventory database, a customer database and/or any other relevant database. Not all embodiments of the present invention require a server 24. That is, methods of the present invention may be performed by the POS terminals 22 themselves in a distributed and/or de-centralized manner.

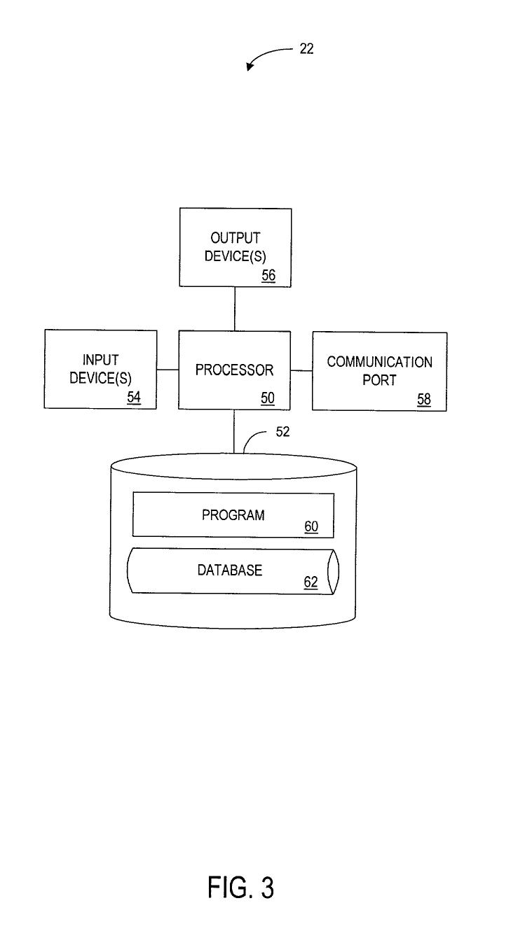

FIG. 3 illustrates in the form of a simplified block diagram a typical one of the POS terminals 22. The POS terminal 22 includes a processor 50 which may be a conventional microprocessor. The processor 50 is in communication with a data storage device 52 which may be constituted by one or more of semiconductor memory, a hard disk drive, or other conventional types of computer memory. The processor 50 and the storage device 52 may each be (i) located entirely within a single electronic device such as a cash register/terminal or other computing device; (ii) connected to each other by a remote communication medium such as a serial port, cable, telephone line or radio frequency transceiver or (iii) a combination thereof. For example, the POS terminal 22 may include one or more computers or processors that are connected to a remote server computer for maintaining databases.

Also operatively connected to the processor 50 are one or more input devices 54 which may include, for example, a key pad for transmitting input signals such as signals indicative of a purchase, to the processor 50. The input devices 54 may also include an optical bar code scanner for reading bar codes and transmitting signals indicative of the bar codes to the processor 50. Another type of input device 54 that may be included in the POS terminal 22 is a touch screen.

The POS terminal 22 further includes one or more output devices 56. The output devices 56 may include, for example, a printer for generating sales receipts, coupons and the like under the control of processor 50. The output devices 56 may also include a character or full screen display for providing text and/or other messages to customers and to the operator of the POS terminal (e.g., a cashier). The output devices 56 are in communication with, and are controlled by, the processor 50.

Also in communication with the processor 50 is a communication port 58 through which the POS terminal 22 may communicate with other components of the POS network 20, including the server 24 and/or other POS terminals 22.

As seen from FIG. 3, the storage device 52 stores a program 60. The program 60 is provided at least in part in accordance with the invention and controls the processor 50 to carry out functions in accordance with the teachings of the invention. The program 60 may also include other program elements, such as an operating system and “device drivers” for allowing the processor 50 to interface with peripheral devices such as the input devices 54, the output devices 56 and the communication port 58. Appropriate device drivers and other necessary program elements are known to those skilled in the art, and need not be described in detail herein. The storage device 52 may also store one or more application programs for carrying out conventional functions of POS terminal 22. Other programs and data not related to the functions described herein may also be stored in storage device 52. In a de-centralized embodiment of the invention, the storage device 52 may contain one or more of the previously described databases as represented generally by database 62 (e.g., a classifier database adapted to store classifiers as described below with reference to FIGS. 4 and 5, a genetic programs database adapted to store genetic programs as described below with reference to FIG. 6, an inventory database, a customer database and/or any other relevant database).

FIG. 4 is a flowchart of a first exemplary process 400 for generating rules and/or offers in accordance with the present invention. As described further below, the process 400 employs an extended classifier system (“XCS”) for rule/offer generation. Extended classifier systems are described in Wilson, “Classifier Fitness Based on Accuracy”, Evolutionary Computation, Vol. 3, No. 2, pp. 149-175 (1995).

Note that while the process 400 is described primarily with reference to the generation of rules/offers within a quick-service restaurant (“QSR”) such as McDonald's, Kentucky Fried Chicken, etc., it will be understood that the process 400 and the other processes described herein may be employed to generate rules/offers within any business setting (e.g., offers within a retail setting such as offers for clothing, groceries or other goods, offers for services, etc.). The process 400 and the other processes described herein may be embodied within software, hardware or a combination thereof, and each may comprise a computer program product. The process 400, for example, may be implemented via computer program code (e.g., written in C, C++, Java or any other computer language) that resides within the server 24 (e.g., within the data storage device 30) and/or within one or more of the POS terminals 22. In the embodiment described below, the process 400 comprises computer program code that resides within the server 24 (e.g., a server within a QSR that controls the offers made by the POS terminals 22 that reside within the QSR). This embodiment is merely exemplary of one of many embodiments of the invention.

With reference to FIG. 4, in step 401, the process 400 starts. In step 402, the server 24 receives order information. For example, a customer may visit a QSR that employs the server 24, and place an order at one of the POS terminals 22 (e.g., an order for a hamburger and fries); and the POS terminal 22 may communicate the order information to the server 24. The order information may include, for example, the items ordered by the customer (e.g., a hamburger, fries, etc.) or any other information (e.g., the identity of the customer, the time of day, the day of the week, the month of the year, the outside temperature, the identity of the cashier, destination information (e.g., eat in or take out) or any other information relevant to offer generation). Note that order information may be received from one or more POS terminals and/or from any other source (e.g., via a PDA of a customer, via an e-mail from a customer, via a telephone call, etc.) and may be based on data stored within the server 24 such as time of day, temperature, inventory or the like.

In step 403, the server 24 translates the order information into a bit stream (e.g., a binary bit stream or sequence of bits that represent the order information). For example, each ordered item identifier may be translated into a predetermined number and sequence of bits, and the bit sequence for all ordered item identifiers then may be appended together to form the bit stream. Other order information such as time of day, day of week, month of year, cashier identity, customer identity, destination (e.g., eat in or take out), temperature, etc., similarly may be converted into bit sequences and appended to the bit stream. Bit streams may be of any length (e.g., depending on the amount of order information, the bit sequence lengths employed, etc.). In one embodiment, a bit stream length of 960 bits is employed.

In one exemplary translation process, each item that may be ordered by a customer (e.g., each menu item), is broken down into its component parts (e.g., a hamburger equals beef, bread, sauce, etc.), each component part is assigned a bit sequence, and the bit sequence for the item is formed from a combination of the bit sequences of each component part of the item (e.g., beef=1, bread=4, sauce=32 so that the hamburger bit sequence equals 1+4+32=37 or 100101). Any other translation scheme may be similarly employed. To keep each bit stream uniform in length (e.g., to allow matching between bit streams and classifiers as described below), each order is assumed to comprise a pre-determined number of items (e.g., six or some other number), and one or more null bit sequences may be employed within the bit stream if less than the number of pre-determined items are ordered.

Once a bit stream has been generated based on the order information (step 403), in step 404, the bit stream is matched to “classifiers” stored by the server 24 (e.g., classifiers stored within the database 38 of the data storage device 30). In at least one embodiment of the invention, each “classifier” comprises a “condition” and an “action” that is similar to an “if—then” rule. That is, if the condition is met (e.g., certain items are ordered on a certain day, at a certain time, by a certain customer, etc.), then the action is performed (e.g., a customer is offered an upsell offer, a dynamically-priced upsell offer, a suggestive sell offer, a switch-and-save offer, a cross-subsidy offer or any other offer). In the process 400 of FIG. 4, a bit steam is matched to a classifier by matching the bits of the bit stream with the bits of the classifier that represent the condition of the classifier. Methods for defining classifiers and for matching order information bit streams with classifiers are described in Appendix A herein. Note that matching may occur at the bit level, at the bit sequence level or at any other level.

In step 405, the server 24 determines if a sufficient number of classifiers have been matched to the bit stream (determined in step 403). For example, the server 24 may require that at least a minimum number of classifiers (e.g., ten) match the bit stream in order to search as much of the available offer space as possible). Note that each matching classifier need not have a unique action.

If a minimum number classifiers has not been matched to the bit stream, the process 400 proceeds to step 406 wherein additional matching classifiers are created (e.g., enough additional matching classifiers so that the minimum number of matching classifiers set by the server 24 is met); otherwise the process 400 proceeds to step 407. Additional matching classifiers may be created by any technique (see, for example, process 500 in FIG. 5), and may be added to the “population” of classifiers stored within the server 24 (e.g., by creating a new database record for each additional matching classifier, or by replacing non-matching classifiers with the additional matching classifiers). A “reward” associated with each additional classifier (described below with reference to step 407) may be determined based on, for example, a weighted average of the reward of each classifier already present within the server 24. Any other method may be employed to determine a reward for additional matching classifiers. Following step 406, the process 400 proceeds to step 407.

In step 407, the server 24 determines (e.g., calculates or otherwise identifies) an expected reward for each matching classifier (e.g., a predicted “payoff” of the action associated with the classifier). Rewards, predicted payoffs and other relevant factors in classifier selection are described further in Appendix A.

In step 408, the server 24 determines whether it should “explore” or “exploit” the matching classifiers. For example, if the server 24 wishes to explore customer response (e.g., take rate) to the actions associated with the matching classifiers (e.g., upsell, dynamically-priced upsell, suggestive sell, switch-and-save, cross-subsidy or other offers), the server 24 may select one of the actions of the matching classifiers at random (step 409). The server 24 may choose to “explore” for other reasons (e.g., to ensure that random actions/offers are communicated to cashiers that may be gaming or otherwise attempting to cheat the system 20). However, if the server 24 wishes to maximize profits, the server 24 may select the action of the matching classifier having the highest expected reward (step 410) given the current input conditions (e.g., order content, time of day, day of week, month of year, temperature, customer identity, cashier identity, weather, destination, etc.).

In step 411, the server 24 communicates the selected action to the relevant POS terminal 22 (e.g., the terminal from which the server 24 received the order information), and the POS terminal performs the action (e.g., makes an offer to the customer via the cashier, via a customer display device, etc.). In step 412, the server 24 determines the results of the selected action (e.g., whether the cashier made the offer to the customer, whether the customer accepted or rejected the offer, etc.) and generates a “reward” based on the result of the action. Rewards are described in further detail in Appendix A. Thereafter, in step 413, the server 24 updates the statistics of all classifiers identified in step 404 and/or in step 406 (see, for example, Appendix A). A classifier's statistics may be updated, for example, by updating the expected reward associated with the classifier. In step 414 the process ends.

Under certain circumstances, the server 24 may wish to introduce “new” classifiers to the population of classifiers stored within the server 24. For example, the server 24 may wish to introduce new classifiers to ensure that the classifiers being employed by the server 24 are the “best” classifiers for the server 24 (e.g., generate the most profits, increase customer traffic, have the best take rates, align offers with current promotions or advertising campaigns, promote new products, assist/facilitate inventory management and control, reduce cashier and/or customer gaming, drive sales growth, increase share holder/stock value and/or achieve any other goals or objective).

FIG. 5 is a flow chart of an exemplary process 500 for generating additional classifiers in accordance with the present invention. The process 500 may be performed at any time, on a random or a periodic basis. As with the process 400 of FIG. 4, the process 500 of FIG. 5 may be embodied as computer program code stored by the server 24 (e.g., in the data storage device 30) and may comprise, for example, a computer program product.

With reference to FIG. 5, the process 500 begins in step 501. In step 502, the server 24 selects two classifiers. The classifiers may be selected at random, may be selected because each has a high expected reward value, may be selected because the classifiers are part of a group of classifiers that match order information received by the server 24, and/or may be selected for any other reason. Thereafter, in step 503, a crossover operation is performed on the two classifiers so as to generate two “offspring” classifiers, and in step 504, each offspring classifier is mutated. Exemplary crossovers and mutations of classifiers are described further in Appendix A. An expected reward also may be generated for each offspring classifier (e.g., by taking a weighted average of other classifiers). In step 505, the offspring classifiers produced in step 504 are introduced into the classifier population of the server 24. For example, new database records may be generated for each offspring classifier, or one or more offspring classifiers may replace existing classifiers. In at least one embodiment, an offspring classifier is introduced in the classifier population only if the offspring classifier has a perceived value (e.g., an expected reward) that is higher than the classifier it replaces. In step 506, the process 500 ends.

Patent applications and patents incorporated by reference herein disclose, among other things, a dynamically-priced upsell module (DPUM) server for providing dynamically-priced upsell offers (e.g., “Digital Deal” offers) to POS terminals clients. Appendix A illustrates one embodiment of the present invention wherein the process 400 (FIG. 4), process 500 (FIG. 5) and/or XCS classifiers in general are implemented within a DPUM server. It will be understood that the present invention may be implemented in a separate server, with or without the DPUM server, and that Appendix A represents only one implementation of the present invention.

In addition to employing XCS techniques, the present invention also employs other evolutionary programming techniques for generating rules and/or offers. Appendix B illustrates one exemplary embodiment of employing Markov and Bayesian techniques with genetic programs for the generation of offers within a QSR (e.g., in association with a DPUM server). It will be understood that the evolutionary programming techniques and other methods described herein and in Appendix B may be employed to generate offers within any business setting (e.g., offers within a retail setting such as offers for clothing, groceries or other goods, offers for services, etc.).

FIG. 6 is a flowchart of a second exemplary process 600 for generating rules and/or offers in accordance with the present invention. The process 600 and the other processes described herein may be embodied within software, hardware or a combination thereof, and each may comprise a computer program product. The process 600, for example, may be implemented via computer program code (e.g., written in C, C++, Java or any other computer language) that resides within the server 24 (e.g., within the data storage device 30) and/or within one or more of the POS terminals 22. In the embodiment described below, the process 600 comprises computer program code that resides within the server 24 (e.g., a server within a QSR that controls the offers made by the POS terminals 22 that reside within the QSR). This embodiment is merely exemplary of many embodiments of the invention.

With reference to FIG. 6, in step 601, the process 600 starts. In step 602, the server 24 receives order information. For example, a customer may visit a QSR that employs the server 24, and place an order at one of the POS terminals 22 (e.g., an order for a hamburger and fries); and the POS terminal 22 may communicate the order information to the server 24. The order information may include, for example, the items ordered by the customer (e.g., a hamburger, fries, etc.) or any other information (e.g., the identity of the customer, the time of day, the day of the week, the month of the year, the outside temperature or any information relevant to offer generation). Note that order information may be received from one or more POS terminals and/or from any other source (e.g., via a PDA of a customer, via an e-mail from a customer, via a telephone call, etc.) and may be based on data stored within server 24 such as time of day, temperature, inventory or the like.

In step 603, the server 24 converts the order information into numerical values. For example, environmental information (e.g., time of day, day of week, month of year, customer identity, cashier identity, etc.) and order item identifiers are each assigned a numeric value (see Appendix B). Thereafter, in step 604, based on the order information (e.g., using the numerical values associated with the order information as an input), the server 24 employs Markov and Bayesian principles to identify associations between ordered items and other items that may be sold to the customer. That is, the server 24 determines all items that may be offered to the customer based on the customer's order (and/or all actions that may be undertaken to offer items to the customer), and a “relevancy” of each item to the customer's order (e.g., a measure of whether the customer will accept an offer for the item).

In step 605, the server 24 scores the potential actions (e.g., offers) that the server may communicate to the POS terminal that transmitted the order information to the server 24 (e.g., all offers that may be made to the customer). In at least one embodiment, the server 24 scores the potential actions by assigning a numeric value to the relevancy of each item/action.

In step 606, the server 24 determines which actions/offers may/should be undertaken (e.g., which offers may/should be made to the customer). For example, the server 24 may choose to eliminate any actions that are not profitable (e.g., upselling an apple pie for one penny), that are impractical or unlikely to be accepted (e.g., offering a hamburger as part of a breakfast meal) or that are otherwise undesirable.

In step 607, the server 24 employs a genetic program to generate offers that are maximized (e.g., to pick the “best” action for the system 20). For example, the server 24 may generate offers/actions based on such considerations as relevancy, profit, discount percentage, preparation time, ongoing promotions, inventory, customer satisfaction or any other factors. Exemplary genetic programs and their use are described in more detail in Appendix B. In general, the server 24 may employ one or more genetic programs to generate offers/actions. In at least one embodiment, the server 24 employs numerous genetic programs (e.g., a hundred or more), and each genetic program is given an equal opportunity to generate offers/actions (e.g., based on a random selection, a “round robin” selection, etc.). In other embodiments, a weighted average scheme may be employed for offer/action generation (e.g., offers/actions may be generated based on a weighted average of one or more business objectives such as generating the most profits, increasing customer traffic, having the best take rates, aligning offers with current promotions or advertising campaigns, promoting new products, assisting/facilitating inventory management and control, reducing cashier and/or customer gaming, driving sales growth, increasing share holder/stock value, promoting offer deal values that are less than a dollar or more than a dollar, etc., based on various factors such as acceptance/take rate, average check information (e.g., to mitigate customer and/or cashier gaming), cashier information (e.g., how well a cashier makes certain offers) and/or based on any other goals, objectives or information). Filters and/or other sort criteria similarly may be employed. Note that weighting, filtering and/or sorting schemes also may be employed during the explore/exploit selection processes described previously with reference to FIG. 4 and process 400.

In step 608, the server 24 communicates the offer (or offers) to the relevant POS terminal 22, which in turn communicates the offer (or offers) to the customer (e.g., via a cashier, via a customer display device, etc.). Thereafter, in step 609, the server 24 determines the customer's response to the offer (e.g., assuming the cashier communicated the offer to the customer, whether the offer was accepted or rejected). Note that whether or not a cashier communicates an offer to a customer may be determined employing voice recognition technology as described in previously incorporated U.S. patent application Ser. No. 09/135,179, filed Aug. 17, 1998, or by any other method. For example, it has been discovered that the time delay between when an offer is presented to a customer and when the offer is accepted by the customer may indicate that a cashier is gaming (e.g., if the time delay is too small, the cashier may not have presented the offer to the customer, and the cashier may have charged the customer full price for an upsell and kept any discount amount achievable from the offer).

In step 610, the server 24 trains the genetic programs stored by the server 24 based on the results of the whether the offer was made by the cashier, accepted by the customer or rejected by the customer (e.g., the server 24 “distributes the reward”). Exemplary reward distributions are described in more detail in Appendix B. In step 611, the process 600 ends.

As with the XCS techniques described with reference to FIG. 4 and Appendix A, new genetic programs may be created using crossover, replication and mutation processes. For example, a new population of genetic programs (e.g., offspring genetic programs) may be generated by “mating” (e.g., via crossover) two genetic programs, by replicating an existing genetic program and/or by mutating an existing genetic program or offspring genetic program. Selection of parent” genetic programs may be based on, for example, the success (e.g., “fitness” described in Appendix B) of the parent genetic programs. Other criteria may also be employed.

In at least one embodiment of the invention, a separate Markov distribution and a separate Bayesian distribution may be maintained for recent transactions and for cumulative transactions, and the server 24 may combine the recent transaction and cumulative transaction distributions (e.g., when making genetic program generation decisions). During promotions, the server 24 may choose to weight the recent transaction distributions heavier than the cumulative transaction distributions (e.g., to increase the response time of the system to promotional offers).

The foregoing description discloses only exemplary embodiments of the invention, modifications of the above disclosed apparatus and method which fall within the scope of the invention will be readily apparent to those of ordinary skill in the art. For instance, the process 400 and/or the process 600 initially may be run in the background at a store or restaurant to “train” the server 24. In this manner, the server 24 (via the process 400 and/or the process 600) may automatically learn the resource distributions and resource associations of the store/restaurant through observation using unsupervised learning methods. This may allow, for example, a system (e.g., the server 24, an upsell optimization system, etc.) to participate in an industrial domain, brand, or store/restaurant without prior knowledge representation. As transactions are observed, the performance increases correspondingly. This observation mode (or “self-learning” mode) may allow the system to capture transaction events and update the weights associated with a neural network until the system has been sufficiently trained. The system may then indicate that it is ready to operate and/or turn itself on.

Other factors may be employed during offer/rule generation. For example, either the process 400 or the process 600 may be employed to decide whether an item should be sold now or in the future (e.g., based on inventory considerations, based on the probability of the item selling later, based on replacement costs, based on one or more other business objectives such as generating the most profits, increasing customer traffic, having the best take rates, aligning offers with current promotions or advertising campaigns, promoting new products, reducing cashier and/or customer gaming, driving sales growth, increasing share holder/stock value, promoting offer deal values that are less than a dollar or more than a dollar, etc., based on various factors such as acceptance/take rate, average check information (e.g., to mitigate customer and/or cashier gaming), cashier information (e.g., how well a cashier makes offers) and/or based on any other goals, objectives or information).

Note that the genetic programming described herein may be employed to automatically create upsell optimization strategies evaluated by business attributes such as profitably and accept rate. Because this is independent of a particular retail sector, this knowledge can be shared universally with other implementations of the present invention operated in other domains (e.g., upsell optimization strategies developed in a QSR may be employed within other industries such as in other retail settings). Particular buying habits and tendencies may be ‘abstracted’ and used by other business segments. That is, genetic programs and processes from one business segment can be adapted to other business segments. For example, the process 400 and/or the process 600 could be used within a retail clothing store to aid cashiers/salespeople in making relevant recommendations to compliment a given customer's initial selections. If a customer selected a shirt and pair of slacks, the system 20 might recommend a pair of socks, shoes, tie, sport coat, etc., depending upon the total purchase price of the ‘base’ items, time of day, day of week, customer ID, etc. Thereafter, the genetic programs employed by the system 20 in the retail clothing setting can be used across industries (e.g., genetic programs may evolve over time into a more efficient application). Therefore, although a given set of rules may or may not apply in another industry a given ‘program’ may have generic usefulness in other retail segments when applied to new transactional data and/or rule sets (manually or genetically generated).

In some embodiments of the invention, unsupervised and reinforcement learning techniques may be combined to automatically learn associations between resources, and to automatically generate optimized strategies. For example, by disentangling a resource learning module from an upsell maximizing module, relevant, universal information may be shared across any retail outlet. Additionally, a reward can be specified dynamically with respect to time, and independently of a domain. Through the use of rewards (e.g., feedback), a “self-tuning” environment may be created, wherein successful transactions (offers), are propagated, while unsuccessful transactions are either discouraged and/or wither and die out. Note that rewards may also be provided to a cashier for successfully consummating an offer (e.g., if a customer accepts the reward), or for simply making offers (e.g., using voice technologies to track cashier compliance). The process 400 and/or the process 600 may be used to automatically determine (e.g., generally for all cashiers and/or specifically for individual cashiers) which incentive programs are most productive for motivating cashiers (e.g., either for a program as a whole or targeted incentives by transaction). For example, the present invention may be employed to determine that a cash based incentive for an entire team is more effective, on average, than individual incentives (or vice versa). However, it may also be determined that an additional individual incentive is particularly effective when the amount of sale exceeds a certain dollar amount (e.g. $20.00).

In one or more embodiments, the present invention may be employed to automatically determine the various pricing levels within a retail outlet that has implemented a tiered pricing system, such as the tiered pricing system described in previously incorporated U.S. Pat. No. 6,119,100. For example, the system 20 may be employed to determine the number (e.g., 2, 3 . . . n), timing and levels of various pricing schemes. Based on consumer behaviors, the system 20 could become “self-tuning” using one or more of the methods described herein.

In at least one embodiment, the present invention may be employed to translate classifiers into “English” (or some other human-readable language). For example, humans (e.g., developers) may wish to understand the operation of the present invention by analyzing its processes and underlying assumptions (e.g., via the examination of classifiers). In this regard, a translation module (e.g., computer program code written in any computer language) may be employed that translates classifiers into a human readable form.

Accordingly, while the present invention has been disclosed in connection with the exemplary embodiments thereof, it should be understood that other embodiments may fall within the spirit and scope of the invention as defined by the following claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method comprising:
receiving order information based on an order of a customer; and
determining an offer for the customer based on:
the order information and
at least one of
a genetic program and
a genetic algorithm.

2. The method of claim 1, further comprising:
determining an order price based on the order information, and in which determining an offer comprises:
determining an offer for the customer based on
the order price, and
at least one of
a genetic program and
a genetic algorithm.

3. The method of claim 2, in which determining an offer comprises:
determining an offer for the customer based on
a round-up amount, and
at least one of
a genetic program and
a genetic algorithm.

4. A method comprising:
receiving order information based on an order of a customer;
determining an offer for the customer based on:
the order information, and
historical offer criteria; and
generating offer criteria for a subsequent offer based on potential upsell items.

5. A method comprising:
generating a base set of rules based on historical order information;
creating new rules based on
the base set of rules and
additional historical information; and
optimizing the new rules based on experience from orders.

6. A device, comprising:
a processor; and
a storage device coupled to the processor and storing instructions adapted to be executed by said processor to perform the method of claim 1.

7. A medium storing instructions adapted to be executed by a processor to perform the method of claim 1.

8. A computer-readable medium that stores data accessible by a program executable on a data processing system, the data being organized according to a data structure that includes:
a plurality of modifiable rules defining offers to provide during a transaction.
